(19) United States
(12) Patent Application Publication
(10) Pub. No.: US 2002/0167607 A1
(43) Pub. Date: Nov. 14, 2002

(54) Method and device for generating a video signal

(76) Inventors: Onno Eerenberg, Eindhoven (NL); Declan Patrick Kelly, Eindhoven (NL); Jozef Pieter Van Gassel, Eindhoven (NL)

Correspondence Address: U.S. Philips Corporation, 580 White Plains Road, Tarrytown, NY, 10591, US

(21) Appl. No.: 10/127,527

(22) Filed: Apr. 22, 2002

(30) Foreign Application Priority Data
Apr. 24, 2001 (EP) 01201477.5

(51) Int. Cl. H04N 7/12

(52) U.S. Cl. 348/439.1; 375/240

(57) ABSTRACT

A method for generating a compressed video signal is described, that is suitable for use in trick play such that an interlace effect is effectively avoided. In a first embodiment, images are displayed repeatedly by generating at least one empty repeat picture, wherein the first empty repeat picture is an interlace elimination picture (E₂(RT→B; RB→B)) referring back to a bottom field memory (MB) in respect of the top frame (T2) as well as in respect of the bottom frame (B2). In a second embodiment, applicable in the case of a field-based coded video sequence, the bottom field (B_{I}1) of an original picture (X1) is replaced by an empty repeat field (EB(RB→T)) referring back to a top field memory (MT).

The present invention relates in general to the art of generating a compressed video signal for use in trick play.

As is commonly known, a conventional television set displays an image by writing horizontal lines on a screen. All lines on the screen in combination define one image frame. The frequency with which the image frames are displayed is an constant value, depending on the format used; in the European format the image frame duration equals 1/25 seconds.

More particularly, during display the even lines are written first, and then the odd lines are written. The combination of the even lines defines an even image field, while the combination of the odd lines defines an odd image field. Thus, each image frame comprises two interlaced image fields. The image field rate is 1/50 seconds in the European format. The field which comprises the topmost line is also referred to as “top field”, while the other field is also referred to as “bottom field”.

In order for the TV-set to be able to correctly display a movie, the image signals must be sent to the television set in the correct rate, corresponding with a display of 50 fields per second. In other words, any source for image signals needs to generate those signals in such a way that the image signals, which include the information of, inter alia, luminance and chrominance of each image pixel, correspond to the rate expected by the television set, i.e. 50 fields per second in the European format.

A video signal can be recorded for instance on tape. For obtaining improved image quality with respect to analogue signal recording, digital recording schemes have been developed. In order to substantially reduce the amount of bits involved, a compression technique has been developed. An established standard coding format is the MPEG format, more particularly MPEG-2 format. Since this coding format is commonly known to persons skilled in the art, the details of this coding format are not explained here. For the sake of completeness, reference is made to document ISO/IEC 13818-2.

A compression technique can be based on elimination of redundant information regarding details that are not visible to the human eye anyway. However, the MPEG compression technique goes further. According to the MPEG syntax, an image can be coded with three different degrees of compression. If an image is coded such that it can be decoded by itself, such image is referred to as intra-coded picture (I). Such I-picture still involves a large number of bits, but it offers the advantage that for decoding this image, only information from the image itself is needed.

In another type of coding, use is made of the fact that successive images are usually very similar, the major differences being caused by motion in the scene. By analyzing the motion, the contents of a new image can be predicted on the basis of a previous image. Such new image is referred to as unidirectionally predictive-coded picture (P); it is coded using motion-compensated prediction from a previous I- or P-picture. An image that is coded as P-picture involves less bits than an I-picture, but when such a picture is decoded, information from a previous I-picture or P-picture may be needed, too.

A still higher degree of compression can be achieved by coding a picture as so-called bidirectionally predictive-coded picture (B). Such picture is coded using motion-compensated prediction from a previous and/or future P-picture or I-picture, but a B-picture can not be used as reference picture for other pictures.

In principle, it would be possible to encode all pictures in a video sequence as I-pictures. However, when good picture quality is required, the bit rate for transmitting such a video sequence would be unacceptably high. Therefore, a video sequence in practice is usually encoded using I-pictures as well as P-pictures as well as B-pictures, wherein the I-pictures, P-pictures and B-pictures are arranged according to a predetermined pattern which is chosen such that the average bit rate has a suitable value. If the video sequence only contains I-pictures and P-pictures, the coding is referred to as “simple profile”; if the video sequence also contains B-pictures, the coding is referred to as “main profile”.

Normally, the structure or pattern of successive pictures is fixed, although this is not prescribed in the MPEG format. An example of such commonly used pattern is IBBPBBPBBPBB, repeatedly. Such combination of an I-picture and all subsequent P-pictures and B-pictures, until the next I-picture, is referred to as “group of pictures (GOP)”. A GOP can be “open” or “closed” depending on whether or not, for decoding the pictures in the GOP, information is needed from the previous or the next GOP.

The above-indicated GOP comprises one I-picture, three P-pictures and eight B-pictures. The total number of bits associated with such GOP can be transmitted with a relatively low bit rate, such that a decoder will receive, on average, a number of bits corresponding with 12 frames in 12/25 seconds (European format). From this, such decoder is able to reconstruct 12 images and present the corresponding video data to a receiving television set in equal time slots of 1/25 seconds. In each GOP however, the number of bits used to encode the I-picture takes up a large percentage of the total number of bits in the GOP. Thus, transmitting the bits corresponding to the I-picture will take much longer than 1/25 seconds, which is compensated by the transmission of the P-pictures and especially the B-pictures, which will each take much less than 1/25 seconds.

A coded digital video sequence can be recorded on a suitable carrier, for instance magnetic tape or magnetic disk or optical disk. When such carrier is played back by a video player, during a normal play situation, the player will output a sequence of frames at a frame rate and bit rate which correspond to the definition in the MPEG syntax, such that a receiving decoder knows what to do with the received signal, i.e. how to decode the received signal, such as to be able to generate 25 frames per second of video plus the corresponding audio for a standard television set. It is, however, desirable to be able to play back a recording in such a way that the recorded scene is displayed at a speed different from the original speed. Such situations, also referred to as “trick play”, are for instance: fast forward play; slow motion forward play; still; slow motion reverse play; reverse play normal speed; fast reverse play. These effects can not be achieved by just playing a recording at a speed different from normal speed, as would be possible by analog recordings. In all such trick play situations, the video player should generate a sequence of compressed digital video data that corresponds to the MPEG standard, in such a way, that a standard decoder will be able to decode the received signal and generate a digital video signal for further processing in a television set. This means, inter alia, that the coded video signal generated by the player must obey the bit rate restrictions of a digital interface, and further must be in conformity with the MPEG format.

The present invention relates particularly to playback situation where the playback speed differs from the normal play speed.

In a first specific aspect, the present invention aims to provide a method for generating a stream of MPEG-coded pictures on the basis of an original MPEG stream, the generated output stream resulting, on display, in a scene having a speed lower than the original MPEG stream. Such stream of MPEG-coded pictures will be referred to as “slow motion stream”.

In a second specific aspect, the present invention aims to provide a method for generating a stream of MPEG-coded pictures on the basis of an original MPEG stream, the generated output stream resulting, on display, in a scene having a speed faster than the original MPEG stream. Such stream of MPEG-coded pictures will be referred to as “fast motion stream”.

Stated differently, the time duration of a slow motion stream is longer than the time duration of the corresponding original stream, whereas the time duration of a fast motion stream is shorter than the time duration of the corresponding original stream. Since in all of said trick play cases, the player should generate a sequence of MPEG-coded pictures having a correct time base and having a correct frame rate and bit rate, which means that the number of pictures per unit time should remain the same on display, a slow motion stream contains more pictures than the corresponding original stream, whereas a fast motion stream contains less pictures than the corresponding original stream.

According to an important aspect of the present invention, in generating a slow motion stream, additional frames are generated which have, on decoding, the effect that pictures are displayed more than once.

According to another important aspect of the present invention, in generating a fast forward (or fast reverse) stream, frames are omitted from the original stream.

WO 98/48573 discloses a method for generating, on the basis of an original MPEG stream, a slow motion stream or a fast motion stream, respectively. For generating the slow motion stream, this publication discloses a method wherein B-frames already present in the original MPEG stream are repeated. I-frames and P-frames are not repeated. A disadvantage of this method is that the quality of the slow motion depends on the GOP structure, while further the progress of the displayed scene is irregular: I-frames and P-frames are displayed only once, whereas B-frames are displayed twice (or more). Another disadvantage of this known method resides in the fact that original MPEG streams do not necessarily comprise B-pictures; in case an MPEG stream does not contain any B-pictures, this known method can not be used at all.

For generating the fast motion stream, said publication discloses a method wherein B-frames are skipped; if all B-frames are skipped while a still faster motion is required, P-frames are skipped; eventually, even I-frames may be skipped. This method also involves some disadvantages. As above, a disadvantage of this method is that the quality of the fast motion depends on the GOP structure. Further, simply skipping B-coded frames and P-coded frames results in a substantial increase of the bit rate of the generated video sequence, which may easily become too high.

According to an important aspect of the present invention, empty predictively-coded frames are generated and introduced into the generated video stream, in order to cause, on display, a repeated display of original I-pictures or P-pictures. Hereinafter, such empty predictively-coded frames will also be referred to as repeat-frames.

In a slow motion situation, the quality of the slow motion will be improved with respect to quality obtained by the method described in WO 98/48573, because I-pictures and/or P-pictures are repeatedly displayed, too. Repeatedly displaying an I-coded picture would also be effected by repeating the corresponding I-frame in the video sequence, but this would result in an increase of the bit rate. In a fast motion situation, depending on the desired speed ratio, the number of frames skipped will be higher than necessary for obtaining the desired speed, which would result per se in a speed greater than desired, and further at least some of the remaining pictures will be repeated by the introduction of said repeat-frames, thus obtaining the correct speed desired. For instance, it is possible to use only the I-coded pictures of the original recording, and to display the corresponding pictures repeatedly by introducing repeat-frames into the GOPS of the outputted video sequence.

In other words, a GOP is constructed by taking an I-picture from the original recording, and then inserting one or more artificial frames which, on decoding, have the effect that said I-picture is displayed again. Thus, the bit rate would remain below allowed levels, while a decoder would still receive a recognizable MPEG-coded video signal. In the above, the phrase “artificial frame” is used to indicate that such frame is not part of the original recording.

The above aspects of the invention are applicable to video streams where the frames are coded progressively. In situations where the frames comprise two interlaced fields, as is usual, a further problem occurs when pictures are displayed repeatedly; in that case, the top field and the bottom field of one frame would be displayed alternatingly for a number of times. If the scene comprises motion, repeatedly displaying a frame would lead to a vibrating impression of the moving part in the scene, which is referred to as “interlace effect”: an observer of the television screen will see a moving object jumping forwards and backwards between two positions with a frequency of 25 Hz, corresponding to the position displayed by the top field and the position displayed by the bottom field, respectively.

It is a further object of the present invention to eliminate this interlace effect.

According to a further important aspect of the present invention, at least the first repeat picture introduced after an original I-picture or P-picture is designed to eliminate, on display, said interlace effect. Hereinafter, such specific repeat picture will also be referred to as “interlace elimination picture”.

In a first embodiment according to the present invention, the interlace elimination picture comprises a top field which, upon decoding and display, causes a repetition of the bottom field of the previous picture, and further comprises a bottom field which, upon decoding and display, also causes a repetition of the bottom field of the previous picture. After such an interlace elimination picture has been processed by a decoder, the field memories of the decoder will contain identical information. Possible further repeat pictures need not be designed as interlace elimination pictures; if such further repeat picture comprises a top field which, upon decoding and display, causes a repetition of the top field of the previous picture, and further comprises a bottom field which, upon decoding and display, causes a repetition of the bottom field of the previous picture, both displayed fields would still be identical, therefore no interlace effect occurs.

In a second embodiment according to the present invention, the interlace elimination picture comprises an intra-coded top field picture, and further comprises a P-coded bottom field picture which, upon decoding and display, causes a repetition of the associated intra-coded top field picture repeating the top field of said intra-coded frame. After such an interlace elimination picture has been processed by a decoder, the field memories of the decoder will also contain identical information, as above, and possible further repeat pictures need not be designed as interlace elimination pictures.

In the above-mentioned embodiments, an original picture is repeated after the original has been displayed. It is, however, also possible to obtain a repeated display of an original picture by displaying the additional picture before the original is diplayed. Thus, in a third embodiment according to the present invention, an interlace elimination preview picture comprises a bottom field which, upon decoding and display, causes a display of the top field of the next picture, and further comprises a top field which, upon decoding and display, also causes a display of the top field of the next picture.

In a fourth embodiment according to the present invention, which can be seen as a combination of the first and third embodiments, the interlace elimination picture comprises a top field which, upon decoding and display, causes a repetition of the bottom field of the previous picture, and further comprises a bottom field which, upon decoding and display, causes a display of the top field of the next picture.

These and other aspects, characteristics and advantages of the present invention will be further clarified by the following description of a preferred embodiment of a control circuitry in accordance with the invention, with reference to the drawings, in which:

FIG. 1 schematically illustrates the structure of an MPEG video sequence;

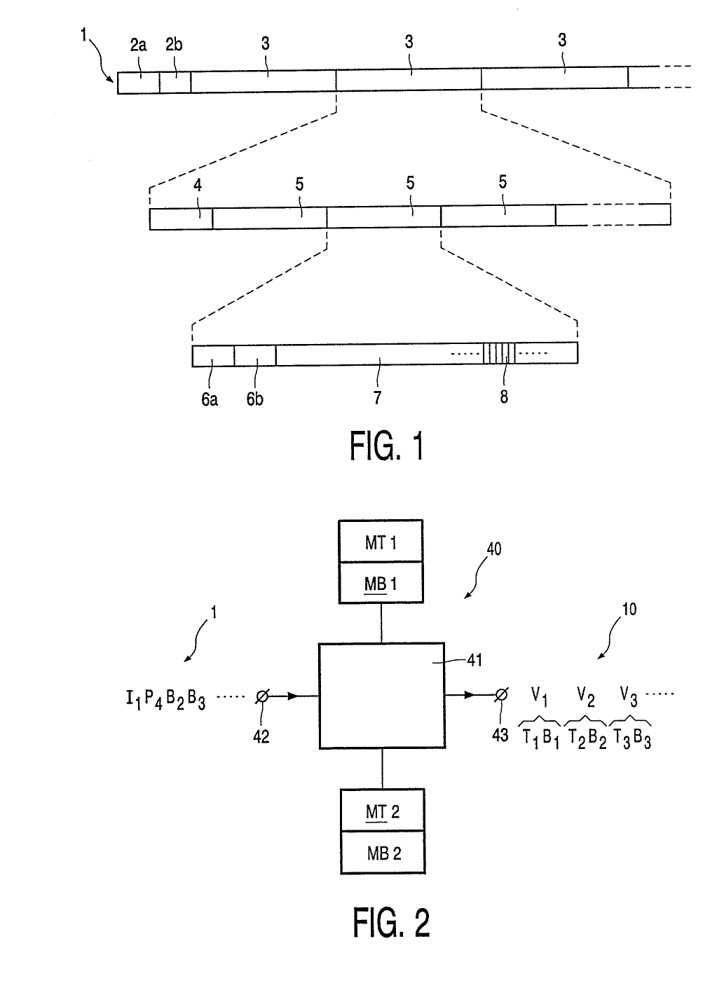

FIG. 2 is a block diagram schematically illustrating an aspect of the operation of a decoder;

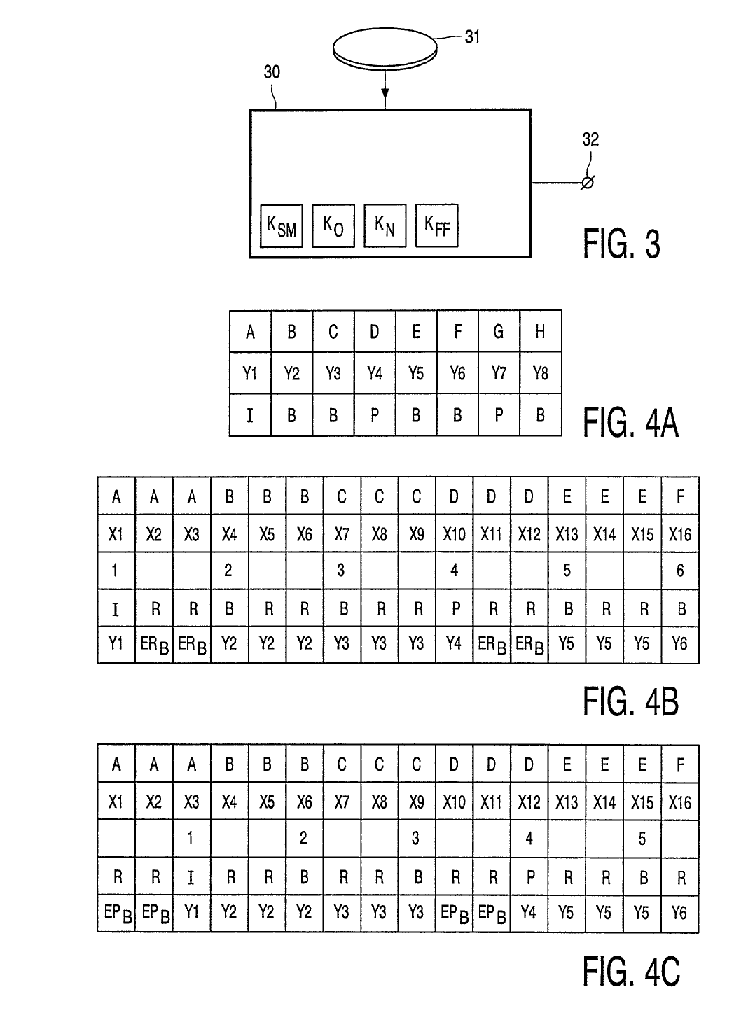

FIG. 3 schematically illustrates a digital player;

FIGS. 4A-4C schematically illustrate the formation of a slow motion video sequence in accordance with the invention;

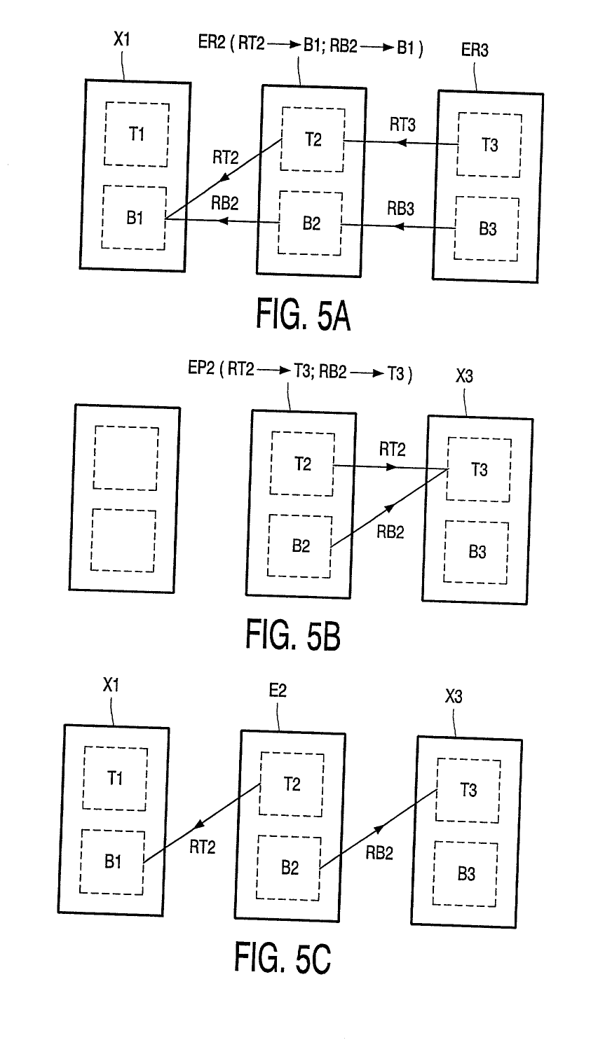

FIGS. 5A-5C schematically illustrate interlace elimination pictures;

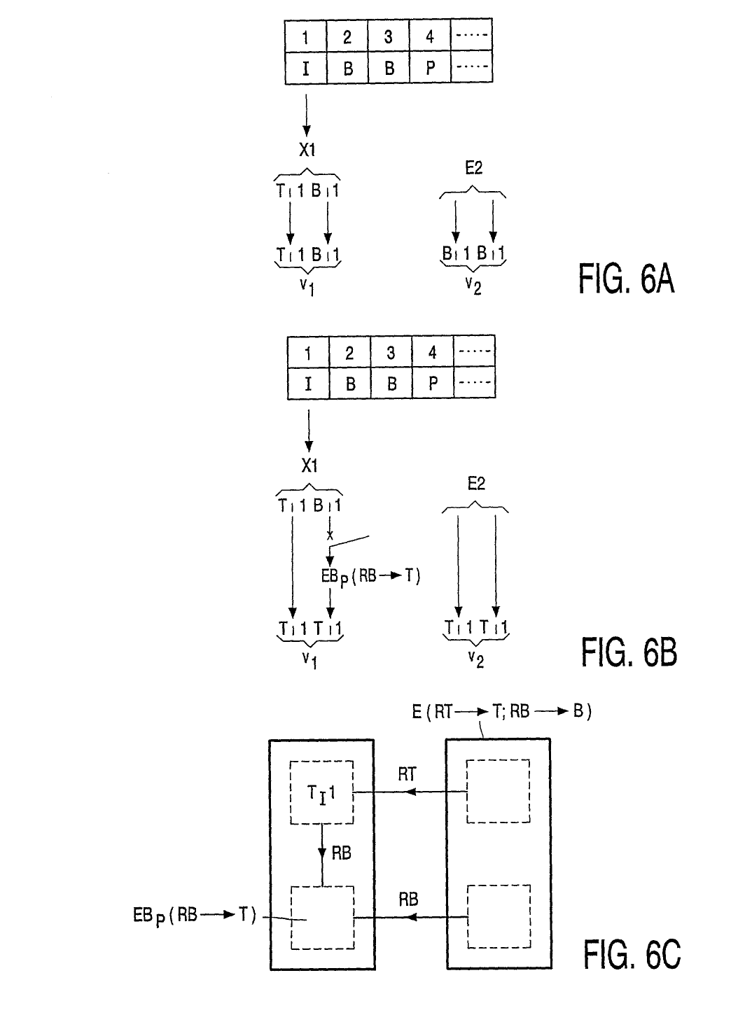

FIGS. 6A-6C schematically illustrate a second embodiment of the method according to the invention;

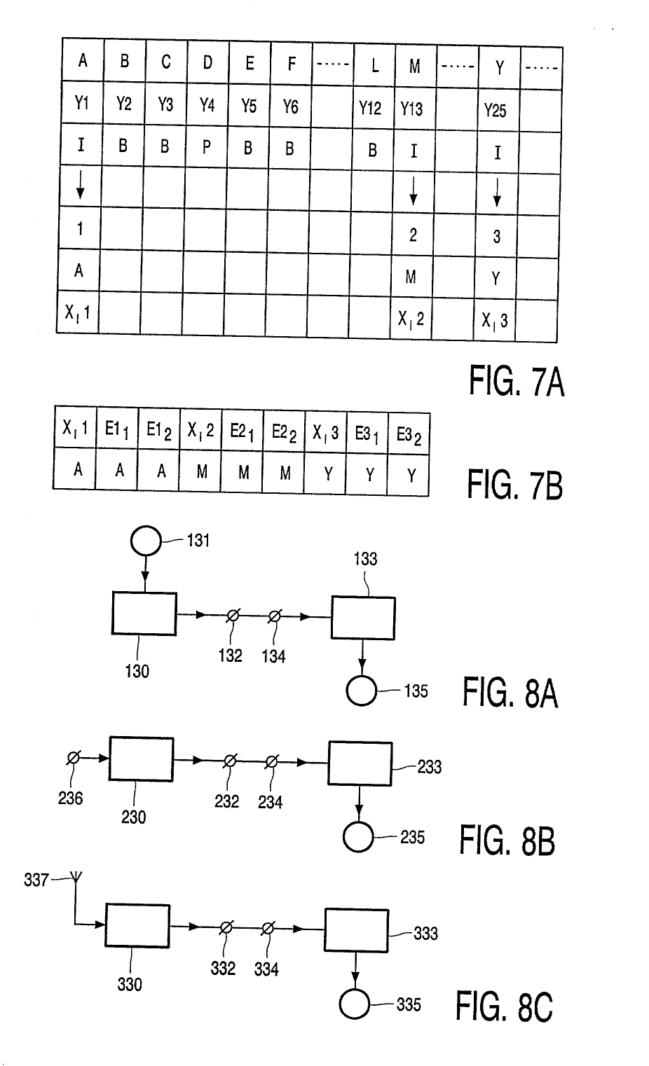

FIGS. 7A-7B schematically illustrate the formation of a fast motion video sequence in accordance with the invention;

FIGS. 8A-8C schematically illustrate different embodiments of an apparatus according to the invention.

It is noted that in FIGS. 8A-8C equal or similar parts are indicated with similar reference numerals in the 100-series, the 200-series, and the 300-series, respectively.

FIG. 1 generally illustrates the structure of an MPEG video sequence 1. Each video sequence 1 starts with a sequence header 2a, followed by a sequence header extension 2b, followed by a plurality of group-of-pictures (GOP) 3. The sequence header 2a comprises information with respect to, inter alia, the frame rate.

Each GOP 3 starts with an optional GOP header 4, followed by a plurality of picture blocks 5. Each GOP header 4 indicates the beginning of a new group-of-pictures.

Each picture block 5 starts with a picture header 6a and a picture header extension 6b followed by the picture data section 7 containing slices 8 which contain the actual picture video information. In picture data section 7, the actual picture information (pixel intensity and color) of the corresponding picture is contained.

When displayed on a standard television set, each interlaced image is displayed by writing two consecutive fields, the combination of such two fields being indicated as frame. It may be that each field of an interlaced image is encoded individually, such that each field of an interlaced image can be decoded individually; in such a case, the picture coding will be indicated as “field-based”. Alternatively, the two fields of an interlaced image may be encoded in a mixed way, such that the fields can not be separated but the frame can only be decoded as a whole; in such a case, the picture coding will be referred to as “frame-based”. Whether a picture is encoded field-based or frame-based is indicated by information in the picture header extension 6b.

Each picture header 6a contains information with respect to the picture type (I, P, B) of the corresponding picture. If the picture header 6a indicates that the corresponding picture is intra-coded or I-type, a decoder is able to reconstruct a picture on the basis of the information contained in the corresponding picture data section 7 alone.

If the picture header 6a indicates that the corresponding picture is predictively coded (P-type or B-type), a decoder may not be able to reconstruct a picture on basis of the information contained in the corresponding picture data section 7 alone. For being able to decode a P-type picture, the decoder may also need the picture video information of a previous I-picture or P-picture. For being able to decode a B-type picture, the decoder may also need the picture video information of a previous I-picture or P-picture and/or the picture video information of a future I-picture or P-picture. An I-picture or P-picture, the picture video information of which is used for reconstructing a predictively coded picture (P-type or B-type), will hereinafter also be referred to as reference picture or anchor picture.

The conventional operation of a video decoder 40 will be briefly explained with reference to FIG. 2. FIG. 2 shows schematically a video decoder 40, which comprises a processor 41 with an input 42 for receiving a coded digital video sequence 1 and an output 43 for outputting a decoded video signal 10, suitable for further processing by a television set. With the processor 41, a picture memory is associated, capable of storing at least two decoded pictures, i.e. four decoded fields. For the sake of the following explanation, said picture memory is illustrated as comprising four field memories, indicated as MT1, MB1, MT2, MB2, intended for storing the top field and bottom field, respectively, of a first picture, and for storing the top field and bottom field, respectively, of a second picture; these illustrative field memories will also be referred to as first top field memory, first bottom field memory, second top field memory and second bottom field memory, respectively. The combination of these illustrative first top and bottom field memories will also be referred to as first memory M1, whereas the combination of these illustrative second top and bottom field memories will also be referred to as second memory M2.

FIG. 2 further illustrates an MPEG-coded video sequence 1 being applied to the input 42 of the processor 41, and a decoded video sequence 10 being outputted at the output 43 of the processor 41. The video sequence 1 comprises a plurality of pictures, each picture being indicated by a character (I, P, B) indicating the type of coding. The decoded video sequence 10 comprises corresponding video pictures V₁, V₂, V₃, V₄, each video picture Vᵢ consisting of a top field Tᵢ and a bottom field Bᵢ. The pictures appear in the video sequence 1 in the order as shown from left to right. Thus, in this example, the MPEG-coded video sequence 1 comprises a first picture which is intra-coded, followed by a second picture which is predictively coded, followed by a third picture which is bidirectionally predictively coded, followed by a fourth picture which is bidirectionally predictively coded. The picture characters are provided with a subscript indicating the display order. Thus, in this example, the first intra-coded picture I₁ is displayed first (V₁), followed by the display of the third picture B₂ (V₂) and the display of the fourth picture B₃ (V₃), after which the second picture P₄ is finally displayed (V₄).

When the processor 41 processes the information in the picture header 6a of the first picture I₁, it will recognize that the first picture is an intra-coded picture, and it will reconstruct the first video picture V₁ only on the basis of the information of the corresponding picture data section 7. First, the first picture I₁ will be decoded, and the top field T₁ of the first reconstructed picture V₁ will be stored in the first top field memory MT1 while the corresponding bottom field B₁ of this reconstructed picture V₁ will be stored in the first bottom field memory MB1. When the first picture I₁ has been received and decoded completely, the first memory M1 (=MT1+MB1) contains the first reconstructed picture V₁.

Secondly, the second picture P₄ is received by the processor 41. When the processor 41 processes the information in the picture header 6a of the second picture P₄, it will recognize that the second picture P₄ is a predictively coded picture, and it will reconstruct the fourth video picture V₄ on the basis of the information of the corresponding picture data section 7 as well as the information in the first memory M1, containing anchor picture I₁. The way in which the information in the memories MT1 and MB1 and the information in the picture data section 7 are combined is part of the MPEG syntax, and needs not be discussed here in detail. The second picture P₄ will be decoded, and the top field T₄ of the fourth video picture V₄ will be stored in the second top field memory MT2 while the corresponding bottom field B₄ will be stored in the second bottom field memory MB2. When the second picture P₄ has been received and decoded completely, the second memory M2 (=MT2+MB2) contains the fourth video picture V₄. In the mean time, the processor 41 has read the first memory M1, and has generated a video signal at its output 43, suitable for processing by a television set, in order to display the top field T₁ and the bottom field B₁ of the first reconstructed picture V₁.

Thirdly, the third picture B₂ is received by the processor 41. When the processor 41 processes the information in the picture header 6a of the third picture B₂, it will recognize that the third picture B₂ is a bidirectionally predictively coded picture, and it will reconstruct the second video picture V₂ on the basis of the information of the corresponding picture data section 7 as well as both the information in the first memory M1, containing anchor picture I₁/V₁, and the information in the second memory M2, containing anchor picture P₄/V₄. Simultaneously, the processor 41 generates the video signal at its output 43, suitable for processing by a television set, in order to display the second video picture V₂. After receiving and processing the third picture B₂, the second memory M2 still contains the fourth video picture V₄ while the first memory M1 still contains the first video picture V₁.

Then, in a similar manner, the fourth picture B₃ is received by the processor 41, and processed to display the third video picture V₃. This mode of receiving and processing a picture is continued as long as bidirectionally predictively coded pictures are received. When the processor 41 receives a subsequent anchor picture, it is decoded and stored in the picture memory while the contents of the second memory M2 are read and displayed, i.e. V₄.

In the following, the invention will be explained in more detail for an exemplary situation of a digital player 30, schematically illustrated in FIG. 3, for playing a record carrier 31, indicated in FIG. 3 as a disk, for instance an optical disk, the record carrier 31 carrying a recorded digital video sequence recorded in normal speed. As is known per se, the player 30 comprises scanning means for scanning the disk for information stored thereon. The construction of these scanning means may be conventional, as will be clear to a person skilled in the art, and needs not be discussed here in detail. For playing such record carrier in trick play mode, the player 30 should be able to physically scan the carrier at a speed differing from normal speed, and generate, at its digital output 32, a trick play video output sequence which corresponds to the MPEG syntax, and which can be processed by the decoder 40. However, the present invention also relates to a digital video recorder which is adapted to receive a “normal” video signal, to generate a trick play video sequence as described above, and to record this trick play video sequence on the carrier; in such a case, playing this recording in “normal” playback, with “normal” speed, will result in a trick play display as compared with the original sequence. Generally, such recorder would record said trick play video sequence as well as the original video sequence, in different tracks.

For allowing a user to select a trick play mode, the player 30 may comprise a fast forward selection key K_{FF} and a slow motion forward key K_{SM}, next to for instance a normal play selection key K_{N}, a stop key K₀, and possible further selection keys which are not shown.

In MPEG, various patterns of the GOPs are possible, and the pattern may even vary in a sequence. In the following, the invention will be explained for an exemplary situation where the coded video sequence comprises only closed GOPs of the format IBBPBBPBBPBB.

In the following, the invention will first be further explained for the case of slow motion.

FIG. 4A illustrates a sequence of pictures, in a normal play situation. The first line in the table indicates successive pictures displayed on a display device such as a standard television set; by way of illustration, it is assumed that the successive pictures show images of the successive characters of the alphabet.

In the second line, the pictures are indicated Yn, n indicating the position of such picture in the display sequence, wherein the numbering starts at 1 with the image of the first letter of the alphabet.

The third line relates to a coded video sequence as recorded on the carrier 31, and shows the picture type, indicated as I, P, or B, of the corresponding pictures for a case where the coded video sequence comprises only GOPs of the format IBBPBBPBBPBB. As indicated earlier, the order of the pictures in the coded video sequence does not correspond to the display order of the pictures. For instance, the fourth (P-coded) picture which causes image “D” is displayed after the third (B-coded) picture which causes image “C”, but has a position in the coded video sequence prior to the position of this third picture. The signal order of the pictures is not shown in FIG. 4A.

FIG. 4B is similar to FIG. 4A, but relates to the display of the same video sequence in a slow motion situation. The first line in the table indicates successive images shown on a display device. In comparison to FIG. 4A, it can be seen that all original images are shown three times in the illustrated situation, thus the playback time is 3 times as long as the normal play time (i.e. the sequence is played back with a slow motion factor 3). It is noted that a slow motion factor 3 could also be achieved if, for instance, the first image would be displayed 4 times and the second image would be displayed 2 times, but this would result in an irregular progress of the video; a constant refresh rate is preferred. On the other hand, however, if it is desired that the slow motion factor is not an integer, this can be achieved using different repetition schemes for different pictures; for instance, if the subsequent pictures would alternatingly be displayed 3 times and 4 times, a slow motion factor equal to 3.5 would result. Other slow motion factors are possible, too.

In the second line in FIG. 4B, the pictures are indicated Xn, n indicating the position of such picture in the slow motion display sequence, wherein the numbering starts at 1 with the first picture showing an image of the first letter of the alphabet.

The third line in FIG. 4B indicates the position of the corresponding original pictures in the original display sequence, and the fourth line indicates the picture type of the original pictures (compare the third line of FIG. 4A). Thus, it should be clear that a video signal which is designed to cause, on decoding and display, the image sequence of the first line of FIG. 4B, contains three times as many pictures as the original video sequence. More particularly, a slow motion video signal in accordance with the invention contains repetition pictures, each repetition picture being designed to cause a repeated display of image information of at least one original picture. In FIG. 4B, such repetition pictures are indicated R in the fourth line.

In this example, the second and third pictures X2 and X3 in the slow motion display sequence cause a repeated display of the image caused by the first picture X1, which in this example is an I-coded original picture Y1. Since I-coded pictures can be decoded without needing information from other pictures, a repeated display of this picture can be achieved by repeatedly sending this picture. This would mean that the second and third pictures X2 and X3 in the slow motion display sequence could in principle be identical to the first picture X1, in which case they would be I-coded. One disadvantage of this solution would be, however, that this would involve a large number of bits. Another disadvantage relates to the interlace effect, which will be discussed later.

According to the invention, the second and third pictures X2 and X3 in the slow motion display sequence are empty repeat pictures, either P-coded or B-coded. These empty repeat pictures, indicated as ER in the fifth line of FIG. 4B, can be P-coded, if the following sequence does not contain any B-coded pictures. If the following sequence does contain B-coded pictures, such as in the present example, a further property of the empty repeat pictures should be taken into account. As will be explained later, the repeat pictures preferably have interlace eliminating properties; in such case, the second and third pictures X2 and X3 in the slow motion display sequence should be B-coded empty pictures, because B-coded pictures leave the picture memories in a decoder unaffected. In the following, it will be assumed that the empty pictures are B-coded; hence, the second and third pictures X2 and X3 are indicated as ER_{B} in the fifth line of FIG. 4B.

When a decoder receives a B-coded picture, it will “construct” an image on the basis of the information in the two picture memories, relating to neighboring anchor pictures, and on the basis of the information of said B-coded picture, which indicates what information from said anchor pictures is to be used and what changes are to be made to this information from said anchor pictures. By way of illustration, if the contents of the two neighboring anchor pictures is symbolised by A1 and A2, respectively, a B-coded picture may be symbolised as containing the parameters α, β and γ, and the creation of the image A3 represented by this B-coded picture may be symbolised as A3=α·A1+β·A2+γ.

An empty B-coded picture repeating a previous picture is a picture in which those changes are zero, and which refers only to the previous anchor picture, thus resulting in a newly constructed image identical to the previous picture, in this case the I-coded first picture X1 of the slow motion display sequence. Such picture, which does not have coded macroblocks, will hereinafter be referred to as B-coded empty repeat picture ER_{B}. In the above symbolisation, α=1, β=0, γ=0. The same applies, mutatis mutandis, to a P-coded picture, which will hereinafter be referred to as P-coded empty repeat picture ER_{P}. Such pictures contain the minimum amount of information necessary for constituting a valid B-picture or P-picture, respectively, but the amount of motion information is zero.

Thus, a repeated display of the I-coded first picture X1 of the slow motion display sequence can be achieved by using B-coded pictures, involving much less bits than repeatedly transmitting the I-coded first picture itself.

It is noted explicitly that the sequence as described above is a valid sequence according to the MPEG format. Consequently, a decoder 40 will have no trouble processing such sequence.

In the example of FIG. 4B, the I-coded first picture X1 of the slow motion display sequence is displayed three times by incorporating into the video sequence two B-coded empty repeat pictures X2 and X3 (ER_{B}) after the original I-coded picture X1. It should be clear that the number of repeat pictures incorporated into the video sequence depends on the desired slow motion factor. Further, as an alternative, instead of using one or more repeat pictures it is possible to use one or more preview pictures incorporated into the video sequence, causing a display before the original I-coded picture X1. This will result in the same visual effect, as illustrated in FIG. 4C, wherein empty preview pictures are indicated as EP_{B}. The phrase “preview picture” is used here to indicate an empty (i.e.: containing no coded macroblocks) B-coded picture which refers only to the future anchor picture, thus resulting in a newly constructed image identical to the future anchor picture. In the above symbolisation, α=0, β=1, γ=0. The phrases “repeated display” and “repeatedly displaying” are used here to cover the situation of a repeat picture as well as the situation of a preview picture.

Further in the example of FIG. 4B, the fifth and sixth pictures X5 and X6 in the slow motion display sequence cause a repeated display of the image caused by the fourth picture X4, i.e. the second original picture Y2, which is a B-coded picture. In order to repeat (or preview) an image which is based on a B-coded picture, the B-coded picture itself should be repeated. Therefore, in this example, for repeating the fourth picture X4, the fifth and sixth pictures X5 and X6 in the slow motion display sequence are identical copies of the fourth picture X4, i.e. the second original picture Y2. Similarly, the eighth and ninth pictures X8 and X9 in the slow motion display sequence are identical copies of the seventh picture X7, i.e. the third original picture Y3. However, as will be explained later, if the repeat pictures X5 and X6 [X8 and X9] are to have interlace eliminating properties, they will not be 100% completely identical to X4 [X7].

Further in this example, the eleventh and twelfth pictures X11 and X12 in the slow motion display sequence cause a repeated display of the image caused by the tenth picture X10, i.e. the fourth original picture Y4, which is a P-coded picture. When decoding a P-coded picture, a decoder needs information from a previous anchor picture, and also the decoder's picture memory is affected. Therefore, a repeated display of this picture can not be achieved by repeatedly sending this picture. According to the invention, the eleventh and twelfth pictures X11 and X12 in the slow motion display sequence are empty repeat pictures ER, either P-coded or B-coded. Similarly as described above with respect to repeating the I-coded picture X1, these empty repeat pictures ER can be P-coded if the following sequence does not contain any B-coded pictures, but if the following sequence does contain B-coded pictures, such as in the present example, and if the repeat pictures are to have interlace eliminating properties, the eleventh and twelfth pictures X11 and X12 in the slow motion display sequence should be B-coded empty pictures ER_{B}, because B-coded pictures leave the picture memory in a decoder unaffected.

Similarly as above, instead of using B-coded repeat pictures ER_{B} causing a display after the original P-coded picture, B-coded preview pictures EP_{B} causing a display before the original P-coded picture could be used (X10 and X11 in FIG. 4C).

As explained in the above, FIG. 4B illustrates a trick play sequence only containing empty repeat pictures ER for repeatedly displaying original pictures after the corresponding original picture has been displayed, while FIG. 4C illustrates a trick play sequence only containing empty preview pictures EP for repeatedly displaying original pictures before the corresponding original picture is displayed. It is also possible to have in one trick play sequence empty repeat pictures as well as empty preview pictures; it is even possible to have an empty preview picture and an empty repeat picture repeatedly displaying one and the same original picture (sequence EP_{B}-Y-ER_{B}).

In the above, two types of empty pictures are explained: an empty repeat picture ER being designed to cause a repeated display of image information of one previous original picture, and an empty preview picture EP being designed to cause a repeated display of image information of one future original picture. The present invention also provides a third type of empty picture, designed to cause, on decoding and display, an interpolation between the previous original picture and the future original picture. More particularly, when a decoder decodes such picture, it will construct an artificial image by averaging the image information of the previous original picture and the image information of the future original picture; in the earlier symbolisation, α=½, β=½, γ=0. Thus, the image as displayed is not a true repetition of the previous original picture or of the future original picture; however, since the image information of the previous original picture is used again in constructing said artificial image (the same applies for the image information of the future original picture), said third type of empty picture will still be considered to constitute an example of a repetition picture. More particularly, said third type of empty picture will be referred to as empty interpolation picture EI; this picture is empty in that it does not contain coded macroblocks.

It should be realised that a picture frame comprises two interlaced fields which are displayed successively. These two fields will be referred to as first field and second field, the first field being the field that is displayed first. In the above-mentioned empty repeat pictures ER, both fields cause a repeated display of previous original fields, whereas both fields of an empty preview picture cause a repeated display of future original fields. The present invention also provides a fourth type of repetition picture, which will be referred to as empty repeat/preview picture ER/P: here, the first field causes a repeated display of a previous original field, whereas the second field causes a repeated display of a future original field.

Thus, according to an important aspect of the present invention, a method is provided for generating, on the basis of an original MPEG video sequence, a slow motion MPEG video sequence which, on decoding and display, results in a slow motion playback of the original sequence, without the need for decoding the original sequence. This is achieved by inserting empty pictures, either B-coded or P-coded, hereinafter generally indicated by the character E. These empty pictures result, on decoding and display, in a repeated display of a previous original picture (ER) or in a repeated display of a future original picture (EP) or in a combination of both (EI; ER/P).

Inserting empty pictures E into a video sequence will have the desired effect of displaying “artificial” pictures on the basis of original pictures, without the need for decoding the original sequence. However, if a picture frame is displayed more than once, the problem of the interlace effect occurs, as explained earlier. This can be understood by realising that each picture frame comprises two interlaced fields which are displayed successively. Normally, the field comprising the top line (top field) is displayed first, followed by the other field (bottom field) of the same picture. However, in MPEG it is possible that the bottom field is displayed first, followed by the top field. In the following, the invention will be further explained for the usual situation that the top field is displayed first; it should however be realised that the invention is not limited to this situation.

The bottom field of a picture is followed by the top field of the next picture. If the two successive picture frames are 100% completely identical, the top field of the second picture is identical to the top field of the first picture, and the bottom field of the second picture is identical to the bottom field of the first picture. If the scene would involve motion, an object would be displayed in a first position when the top field of the first picture is displayed, and would be displayed on a second location when the bottom field of the first picture is displayed. When subsequently the top field of the second picture would be displayed, which is identical to said top field of the first picture, this moving object would be shown again at the first location shown by said top field of the first picture. In other words, such moving object would jump forward and backward between these two locations.

It is a further object of the present invention to overcome this problem.

According to the present invention, in order to overcome this problem, an empty picture E is preferably structured such that, on decoding and display, each field of this empty picture E causes a repeated display of the temporally closest field of the anchor picture to which said empty picture E refers.

An empty repeat picture ER refers to an earlier anchor picture; the temporally closest field of this anchor picture is its second field, i.e. its bottom field. Therefore, in accordance with the present invention, an empty repeat picture ER with interlace eliminating properties causes, on decoding and display, two times a repeated display of the bottom field of the earlier anchor picture.

An empty preview picture EP refers to a future anchor picture; the temporally closest field of this anchor picture is its first field, i.e. its top field. Therefore, in accordance with the present invention, an empty preview picture EP with interlace eliminating properties causes, on decoding and display, two times a repeated display of the top field of the future anchor picture.

An empty interpolation picture EI refers to an earlier anchor picture as well as to a future anchor picture; the temporally closest field of the earlier anchor picture is its second field, i.e. its bottom field, and the temporally closest field of the future anchor picture is its first field, i.e. its top field. Therefore, in accordance with the present invention, an empty interpolation picture EI with interlace eliminating properties causes, on decoding and display, two times a display of an interpolation between the bottom field of the earlier anchor picture and the top field of the future anchor picture. However, the interlace effect is already reduced if an empty interpolation picture EI causes, on decoding and display, a display of an interpolation between the top field of the earlier anchor picture and the top field of the future anchor picture followed by a display of an interpolation between the bottom field of the earlier anchor picture and the bottom field of the future anchor picture.

An empty repeat/preview picture ER/P refers to an earlier anchor picture as well as to a future anchor picture; the temporally closest field of the earlier anchor picture is its second field, i.e. its bottom field, and the temporally closest field of the future anchor picture is its first field, i.e. its top field. Therefore, in accordance with the present invention, an empty repeat/preview picture ER/P with interlace eliminating properties causes, on decoding and display, a display of the bottom field of the earlier anchor picture followed by a display of the top field of the future anchor picture.

As is known to persons skilled in the art, the macroblock headers of a picture contain a reference parameter MVFS (Motion Vertical Field Select); depending on the value of this parameter, a decoder will use a macroblock from the top field or the bottom field of the anchor picture relied on. Although in fact each macroblock has its own reference parameter MVFS, while the value of the reference parameter MVFS may be different for different macroblocks, in the following it will be assumed that the value of the reference parameter MVFS is the same for all macroblocks in a field. For the sake of the following discussion, this will be expressed by defining a top reference information parameter RT for an entire top field and a bottom reference information parameter RB for an entire bottom field. If such reference information indicates the top field of an anchor picture, this will be indicated as the value→T; on the other hand, if such reference information indicates the bottom field of an anchor picture, this will be indicated as the value→B.

Normally, the top reference information parameter RT indicates a reference to a top field (RT→T) whereas the bottom reference information parameter RB normally indicates a reference to a bottom field (RB→B). An empty picture E fulfilling this normal relationship would in this notation be indicated as E(RT→T; RB→B). However, this is not a necessity in the MPEG syntax, and the present invention is based on the recognition of this fact.

FIG. 5A schematically illustrates a first picture X1, having a top field T1 and a bottom field B1. This first picture X1 is an original picture, either I-coded or P-coded, and is followed by an empty repeat picture ER2, either P-coded or B-coded, generated by the player 30. The empty repeat picture ER2 has a top field T2 and corresponding top reference information parameter RT2, and a bottom field B2 and corresponding bottom reference information parameter RB2. The bottom reference information parameter RB2 indicates a reference to the bottom field B1 of the first picture X1(RB2→B1), shown in FIG. 5A as an arrow RB2 pointing back from the bottom field B2 of this repeat picture ER2 to the bottom field B1 of the first picture X1.

If the empty repeat picture ER2 would be designed for causing, on decoding and display, an exact repetition of both top and bottom field pictures of the first picture X1, the top reference information parameter RT2 would indicate a reference to the top field T1 of the first picture X1 (RT2→T1). However, as explained earlier, the interlace effect would occur then. According to the invention, this interlace effect is avoided if the top reference information parameter RT2 also indicates a reference to the bottom field B1 of the first picture X1 (RT2→B1), as schematically illustrated in FIG. 5A as an arrow RT2 pointing back from the top field T2 of this repeat picture ER2 to the bottom field B1 of the first picture X1. Such empty repeat picture ER2(RT2→B1; RB2→B1) causes, on decoding and display, two times a repetition of the bottom field picture B1 of the first picture X1, which bottom field picture B1 is, in relation to the repeat picture E2, temporally the closest field of the first picture X1, namely the last field.

It can easily be seen that the interlace effect is effectively avoided in this way: on decoding and display, the two pictures X1 and ER2 cause the successive display of the images T1, B1, B1, B1. Therefore, said empty repeat picture ER2(RT2→B1; RB2B→B1) generated by the player 30 will also be indicated as “interlace elimination picture”.

If it is desired that the first picture X1 be repeated again in order to obtain a higher slow motion factor, one or more further empty repeat pictures ER3, ER4, etc. can be inserted into the video sequence after ER2. If the empty repeat pictures ER2, ER3, ER4, etc are B-coded, they should all be identical, i.e. of the type ER_{B}i(RTi→B1; RBi→B1). If, however, the first empty repeat picture ER2 is P-coded, the contents of the corresponding top and bottom field memories of a decoder will be identical after decoding and further processing such P-coded repeat picture ER_{P}2; then, the top and bottom fields of further repeat pictures, whether P-coded or B-coded, may refer to any one of the fields T2/B2 of such P-coded repeat picture ER_{P}2, for instance ER3(RT3→T2; RB3→B2), as schematically illustrated in FIG. 5A.

As explained earlier, instead of repeating the display of a picture by having this picture followed by an empty repeat picture, it is also possible to have this picture preceded by an empty preview picture. Similar to FIG. 5A, FIG. 5B schematically illustrates a picture X3, having a top field T3 and a bottom field B3. This picture X3 is an original picture, either I-coded or P-coded, and is preceded by an empty preview picture EP2, B-coded. This empty preview picture EP_{B}2 has a top reference information parameter RT2 and a bottom reference information parameter RB2. The top reference information parameter RT2 indicates a reference to the top field T3 of the picture X3 (RT2→T3), shown in FIG. 5B as an arrow RT2 pointing forward from the top field T2 of this repeat picture EP2 to the top field T3 of the picture X3. If the empty preview picture EP2 would be designed for causing, on decoding and display, an exact replica of both top and bottom field pictures of said original picture X3, the bottom reference information parameter RB2 would indicate a reference to the bottom field B3 of the picture X3 (RB2→B3). However, as explained earlier, the interlace effect would occur then. According to the invention, this interlace effect is avoided if the bottom reference information parameter RB2 indicates a reference to the top field T3 of the original picture X3 (RT2→T3), too, as schematically illustrated in FIG. 5B as an arrow RB2 pointing forward from the bottom field B2 of this repeat picture ER2 to the top field T3 of the original picture X3. Such empty preview picture EP2(RT2→T3; RB2→T3) causes, on decoding and display, two times a display of the top field picture T3 of said picture X3, which top field picture T3 is, in relation to the preview picture E2, temporally the closest field of said picture X3, namely the first field.

It can easily be seen that the interlace effect is effectively avoided in this way: on decoding and display, the two pictures EP2 and X3 cause the successive display of the images T3, T3, T3, B3. Therefore, said empty preview picture EP2(RT2→T3; RB2→T3) generated by the player 30 will also be indicated as “interlace elimination picture”.

If it is desired that the original picture X3 be previewed more times in order to obtain a higher slow motion factor, one or more further empty preview pictures EP can be inserted into the video sequence before E2. Since the empty preview pictures should be B-coded, they should all be identical, i.e. of the type EP_{B}i(RTi→T3; RBi→T3).

A special situation arises in the case the original video sequence only contains anchor pictures, i.e. no B-coded pictures, and if a slow motion factor 2 (or 4, 6, etc) is desired. FIG. 5C schematically illustrates a first picture X1, having a top field T1 and a bottom field B1. This first picture X1 is an original anchor picture, either I-coded or P-coded, and is followed by an empty picture E2, B-coded, which in turn is followed by a third picture X3, which is a second original anchor picture, either I-coded or P-coded. The empty picture E2 has a top field T2 and corresponding top reference information parameter RT2, and a bottom field B2 and corresponding bottom reference information parameter RB2. The third picture X3 has a top field T3 and a bottom field B3.

In the earlier examples, the second picture E2 is either an empty repeat picture having both its top reference information parameter RT2 and its bottom reference information parameter RB2 referring to B1 (FIG. 5A), or an empty preview picture having both its top reference information parameter RT2 and its bottom reference information parameter RB2 referring to T3 (FIG. 5B). If, in the present example, the second picture E2 would be of such type, the display sequence would be

T1, B1, B1, B1, T3, B3, B3, B3 . . . in the case of FIG. 5A, or

T1, T1, T1, B1, T3, T3, T3, B3 . . . in the case of FIG. 5B. Thus, the refresh rate of the field pictures would be irregular. This can, according to the invention, be improved if the top reference information parameter RT2 would indicate a reference to the bottom field B1 of the first picture X1 (RT2→B1) while the bottom reference information parameter RB2 would indicate a reference to the top field T3 of the third picture X3 (RB2→T3), as schematically illustrated in FIG. 5C. Thus, the empty picture E2 would have a repeat top field and a preview bottom field. Such empty repeat/preview picture E2(RT2→B1; RB2→T3) causes, on decoding and display, one repetition of the bottom field picture B1 of the first picture X1, which bottom field picture B1 is, in relation to the picture E2, temporally the closest field of the first picture X1, namely the last field, as well as one preview of the top field picture T3 of the third picture X3, which top field picture T3 is, in relation to the picture E2, temporally the closest field of the third picture X3, namely the first field.

On decoding and display, the three pictures X1, E2 and X3 cause the successive display of images T1, B1, B1, T3, T3, B3. Thus, not only is the interlace effect effectively avoided, but also the field refresh rate is constant. As above, said empty repeat/preview picture E2(RT2→B1; RB2→T3) generated by the player 30 will also be indicated as “interlace elimination picture”.

The same principle would apply if the number of empty pictures between two original anchor pictures is an odd number larger than one: in all of such cases, the central empty picture can be such combined repeat/preview picture.

In the above, no distinction has been made between frame-based coding and field-based coding. If pictures in the coded video sequence, as recorded on the carrier 31, are frame-based coded, each picture block contains the information of a top field and a bottom field in a mixed way. However, after decoding, the memory of the decoder 40 comprises top field information and bottom field information in a separated way. On the other hand, if the coded video sequence as recorded on the carrier 31 is field-based coded, each picture block contains the information regarding one field only, i.e. either a top field or a bottom field. The above explanation is valid for field-based coded pictures as well as for frame-based coded pictures.

It is noted that the empty repeat pictures and preview pictures as described above can be either field-based coded or frame-based coded, independent of the fact whether the recorded video sequence is field-based coded or frame-based coded.

FIG. 6 illustrates another embodiment of the present invention, which can be used if the coded video sequence as recorded on the carrier 31 contains field-based coded pictures. This embodiment can be used in cases where the recorded video sequence is field-based coded, because now the two fields of a frame can be manipulated individually while still being coded. In the following, the invention will be explained again for the situation where the picture to be processed is an intra-coded picture (I), but the same applies if the picture to be processed is a predictively coded picture (P).

When a picture is field-based coded, the top field of the interlaced image is coded in a separate picture block 5 with an associated picture header 6a and an associated picture header extension 6b, while also the bottom field of the interlaced image is coded in a separate picture block 5 with an associated picture header 6a and an associated picture header extension 6b, each of these picture blocks 5 containing the information of the top field and the bottom field. If the picture is predictively coded, a top reference information parameter RT and a bottom reference information parameter RB, respectively, can be considered associated with each field, similarly as described above, wherein each of said reference information RT and RB, respectively, can either refer to a top field memory (→T) or to a bottom field memory (→B).

Normally, both fields of any image will be of the same type, i.e. both will be I-type or P-type or B-type coded. Then, an intra-coded picture X_{I}1 in an original video sequence will comprise an individually intra-coded top field and an individually intra-coded bottom field, respectively indicated as T_{I}1 and B_{I}1 in FIG. 6A.

The player 30 may be designed to output both of these intra-coded fields subsequently, and to generate and output an empty repeat picture ER2, just as described above. Then, as described above, upon decoding and displaying, first the top field T_{I}1 will be displayed, followed by a repeated display of the bottom field B_{I}1 (see FIG. 6A).

However, according to the present embodiment of the present invention, the player 30 in this implementation is designed to replace the second picture block of the intra-coded picture X_{I}1, i.e. the intra-coded bottom field B_{I}1, by an individually (field-based) predictively coded empty bottom field EB_{P}, having a reference to the top field memory; this field generated by the player 30 is indicated as EB_{P}(RB→T) in FIG. 6B.

Upon decoding, the decoder 40 will first construct a top field on the basis of the top field T_{I}1. Then, on the basis of the individually (field-based) predictively coded empty bottom field EB_{P}(RB→T) generated by the player 30, the decoder 40 will construct a bottom field for display by repeating the contents of its top field memory MT. Thus, the bottom field of the first picture V₁ as displayed will be identical to its top field T_{I}1, as illustrated in FIG. 6B. In view of the fact that the two fields of this frame are identical, it will be evident that any interlace effect is effectively eliminated. Therefore, said individually (field-based) predictively coded empty bottom field EB_{P}(RB→T) generated by the player 30 will also be indicated as “interlace elimination field”.

FIG. 6C illustrates this interlace elimination field in a manner similar to FIG. 5.

After this, the bottom field memory MB of the decoder 40 will have the same contents as the top field memory MT. For repeated display of this picture, the player 30 can generate an empty repeat picture ER2, either P-type or B-type, either frame-based coded or field-based coded, in which the top field reference information RT and the bottom field reference information RB may both refer to the bottom field memory, as described above, but this is not necessary to obtain the interlace elimination effect: the top field reference information RT of such repetition picture may also refer to the top field memory, since the contents of the top field memory and the bottom field memory will be identical. In fact, the values of the top field reference information RT and the bottom field reference information RB are now irrelevant. Upon decoding such repetition picture ER2, the decoder 40 will output the contents of its bottom memory MB two times or, alternatively, the contents of its top field memory followed by the contents of its bottom field memory, respectively, leading to the same visual result, namely the display of a second picture V₂ comprised of a top field picture and a bottom field picture each having the same contents T_{I}1 as the top field of the first picture V₁.

It should be clear that in this case, too, no disturbing vibrating motion will be observed, because all fields as displayed are identical.

In an alternative embodiment, the same visual effect can be achieved if the intra-coded bottom field B_{I}1 is replaced by a copy of the intra-coded top field T_{I}1, as will be clear to a person skilled in the art. However, this will involve more bits.

In the above, it has been explained with reference to FIGS. 4A-C how additional pictures can be generated on the basis of original pictures, repeating the display of these pictures, for the case that these original pictures are I-coded, P-coded or B-coded. It has further been explained, with reference to FIGS. 5A-C and 6A-C, how a possible interlace effect can be effectively eliminated for the case that these original pictures are I-coded or P-coded. For the case that said original pictures are B-coded, it is not possible to repeat (or preview) the display of an original B-coded picture frame using an interlace eliminating repeat (or preview) picture because, as explained, a repeat picture for repeating such B-coded picture is a copy of such B-coded picture itself.

The present invention also provides a solution to this problem, for the case that the original B-coded picture frame is field-based coded. In such case, a B-coded picture X_{B}1 in an original video sequence will comprise an individually B-coded top field T_{B}1 and an individually B-coded bottom field B_{B}1. In order to allow repetition of this picture while allowing for interlace elimination, the player 30 in this implementation is designed to generate a B-coded repeat (or preview) picture wherein the top field and the bottom field are identical, and are copies of one of the fields of the original picture. The player 30 may even be designed to replace the second picture block of the B-coded original picture X_{B}1, i.e. the B-coded bottom field B_{B}1, by a copy of the B-coded top field T_{B}1.

Upon decoding the manipulated B-coded picture frame, the decoder 40 will first construct a top field on the basis of the original top field T_{B}1, and will then construct a bottom field on the basis of the bottom field B_{B}1 generated by the player 30, which is, as mentioned, identical to the original top field T_{B}1. Thus, the bottom field of the first picture V₁ as displayed will be identical to its top field. In view of the fact that the two fields of this frame are identical, it will be evident that any interlace effect is effectively eliminated. Therefore, said “artificial” bottom field generated by the player 30 will also be indicated as “interlace elimination field”.

In the above, the present invention is explained in detail for the case of slow motion: in short, original pictures are displayed more than once. The present invention is, however, also applicable for the case of fast play back, as will be explained in the following with reference to FIG. 7A.

The first three lines in the table of FIG. 7A relate to an original video sequence. The first line in FIG. 7A indicates successive images as would have been displayed on a display device on the basis of an original video sequence. The second line indicates the position of the successive pictures in the original sequence, on display. The third line indicates the picture type of these original pictures.

The following lines in the table of FIG. 7A relate to a trick play sequence generated by the player 30 on the basis of the original sequence. The trick play sequence contains less pictures than the original sequence; in fact, the trick play sequence is generated by skipping some original pictures. The pictures from the original sequence that are used in generating the trick play sequence, i.e. “extracted” from the original sequence, are indicated by arrows in the fourth line of FIG. 7A. The fifth line indicates the position of a picture in the trick play sequence, and the sixth line indicates the image generated by the pictures in the trick play sequence.

It should be clear from FIG. 7A that not all original images are displayed. If images are skipped, a faster motion is achieved than in normal play, the fast forward factor depending on the number of images skipped. In the present example, it will be assumed that the original coded video sequence comprises only GOPs containing 12 pictures, each GOP being of the format IBBPBBPBBPBB, and that the player 30, in a fast forward trick play mode, uses only the I-pictures and skips the remaining pictures. The extracted intra-coded pictures are indicated as X_{I}1, X_{I}2, X_{I}3, etcetera in the seventh line of FIG. 7A.

Apart from bit-rate considerations, a video sequence which only comprises these intra-coded pictures extracted from such original video sequence could be sent to a TV screen, and the resulting display would correspond to a fast forward factor 12.

If a higher fast forward factor is desired, also I-coded pictures may be skipped. In order to allow for trick play with a lower fast forward factor or a lower refresh rate, the video player 30 inserts empty pictures E (empty repeat pictures ER and/or empty preview pictures EP and/or empty interpolation pictures EI and/or empty repeat/preview pictures ER/P). When decoded by the decoder 40, these pictures E result in an additional display of the previous intra-coded picture (repeat) or of the next intra-coded picture (preview) or of a combination.

FIG. 7B illustrates the pictures of an exemplary trick play sequence. The first line of FIG. 7B indicates the extracted intra-coded pictures X_{I}1, X_{I}2, X_{I}3, etcetera from the original sequence, as also indicated in the seventh line of FIG. 7A. The first line of FIG. 7B further indicates that this exemplary trick play sequence contains, after each original intra-coded pictures X_{I}1, X_{I}2, X_{I}3, etcetera, always two empty pictures E, numbered as Eiⱼ, the number i referring to the number of the preceding original intra-coded picture X_{I}i, the number j distinguishing the empty pictures referring to the same original picture. In this example, the empty pictures are all repeat pictures.

The images displayed on decoding of this exemplary trick play sequence are indicated in the second line of FIG. 7B. It should be clear that this exemplary trick play sequence results in an overall fast forward factor 4 with respect to the original sequence.

The more empty repeat pictures E inserted after an original picture in the extracted sequence, the more times this original picture will be displayed, and the lower the fast forward factor will be. As will be clear to a person skilled in the art, different fast forward factors can be achieved by repeating each picture a different number of times. Further, it is not necessary that all pictures are repeated the same number of times: for instance, if a first picture would be displayed three times while a second picture would be displayed two times, an average fast forward factor 4.8 would be achieved.

Similarly as described earlier in respect of slow motion, a trick play sequence may comprise repeat pictures as well as preview pictures as well as interpolation pictures as well as repeat/preview pictures.

In view of the fact that pictures are displayed repeatedly, the interlace effect problem might occur. In order to overcome this problem, the digital video player 30 is, in this exemplary implementation, designed to generate, after each original picture X_{I}i to be repeated, the first empty repeat picture Ei₁ as an interlace elimination picture Ei₁(RT→B;RB→B), either P-coded or B-coded. Or, if the intra-coded pictures X_{I}i are field-based coded, the digital video player 30 may be designed to replace the original bottom field of an original intra-coded picture X_{I}i by a copy of its corresponding top field or, alternatively, by an individually (field-based) predictively coded empty bottom field EB_{P}(RB→T) generated by the player 30, as described above with reference to FIGS. 6A-C.

In the above, the invention for a fast motion situation is described by way of example in a situation where only I-frames are extracted from an original sequence. However, it is also possible in accordance with the present invention to use original P-frames, i.e. to repeat the display of predictively coded frames. After all, as explained above, after a P-frame has been processed, the video memories MT and MB of a decoder will contain the last displayed picture. This picture can be displayed again by sending an empty repeat frame to the decoder, and the interlace effect can be eliminated by constructing this empty repeat frame as an interlace elimination frame, just as described above.

In the above, it is described how an MPEG-2 encoded video signal can be generated, suitable for transmission over a digital interface, such that a receiving device receives a signal that, on the one hand, fully satifies the MPEG syntax and, on the other hand, on decoding and display results in trick play, i.e. a display speed different from normal speed of the original sequence. A special case is pause. If a player is switched to pause mode, the player normally stops sending video signals over the interface. In the case of a digital transmission link, such might result in the receiving device entering into an undefined state, and a display connected to such receiving device might go blank; if at a later time the transmission is resumed, the receiving device may have difficulty in decoding the received signal, and the display may stay blank for some time after the player will have been switched back to play mode.

In order to avoid these problems, the sending device (player) is, according to the present invention, preferably equipped to generate and transmit a continuous stream of empty repeat pictures over the digital interface, wherein at least the first empty picture of such stream is an interlace elimination picture. Then, a receiving decoder will receive a valid MPEG stream, and will continue to display a still image as long as the player is in pause mode.

In a preferred implementation, the sending device, when switched to pause mode, continues normal play till an intra-coded picture (on average, this normally takes less than 0.25 sec), and then starts sending empty pictures.

The same solution is possible for a different problem. If a player is switched to still image mode, it is the user's intention that a display continuously shows the present image. Normally, this is effected by the player continuously reading one image from record, and continuously sending the video signal as read. Especially in the case of magnetic recordings, this might damage the record. Further, in the case of I-coded pictures, the necessary bit rate would be very high, whereas in the case of P-coded pictures, simply repeating these pictures is not possible. In order to avoid these problems, the sending device (player) is, according to the present invention, preferably equipped to generate and transmit, if switched to still image mode, a continuous stream of empty repeat pictures over the digital interface, wherein at least the first empty picture of such stream is an interlace elimination picture. Then, a receiving decoder will receive a valid MPEG stream, and will continue to display a still image as long as the player is in still image mode.

If a receiving decoder only receives a continous stream of empty repeat pictures, it can not recover from possible transmission errors. Further, a receiving decoder can not display a still image on the basis of a continous stream of empty repeat pictures alone, unless its field memories contain the correct anchor information; if the decoder is switched on after the player has entered the pause mode or the still image mode, its memories are empty. These problems can be avoided if the sending device (player), in accordance with a further preferred embodiment of the present invention, is equipped to insert, from time to time, an original intra-coded picture from the original stream into said continous stream of empty repeat pictures. In fact, the player will then generate artificial GOPs consisting of one original intra-coded picture and a predetermined number of empty repeat pictures, said original intra-coded picture being the same for all such artificial GOPs. Such artificial GOPs may have mutually identical lengths, but this is not essential: within limits, the lenghts of such artificial GOPs may be chosen arbitrarily, taking into consideration the desired random access time and the average bit rate over the interface. Further, in such artificial GOPs, the empty pictures can only be of P-type, because B-coded pictures can only be decoded if the future anchor picture has been received and is stored in a buffer memory.

Thus, the present invention provides a method, and devices implementing this method, for generating a compressed video signal for use in trick play, based on an original coded video sequence, the compressed video signal as generated resulting, on decoding and display, in a play back speed different from the original speed while the bit transfer rate remains limited. According to the invention, only a limited number of pictures are extracted from the original video sequence, which results in an increased play back speed, while further each extracted picture is repeated at least once in such a way that an interlace effect is effectively avoided. Repeated display of a picture is obtained by inserting at least one empty repeat or preview picture in the generated video sequence.

In a first embodiment, the interlace effect is effectively avoided because the first repeat picture immediately following the original picture to be repeated is an interlace elimination picture having top field reference information RT and bottom field reference information RB both referring to a bottom field memory, resulting in repeated display of the original bottom field.

In a second embodiment, the interlace effect is effectively avoided because the bottom field of the original picture to be repeated is replaced by an interlace elimination bottom field having bottom field reference information RB referring to a top field memory, resulting in repeated display of the original top field.

It should be clear to a person skilled in the art that the scope of the present invention is not limited to the examples discussed in the above, but that several amendments and modifications are possible without departing from the scope of the invention as defined in the appending claims. For instance, the player 30 may be designed for allowing a user to input a selected fast forward factor, and to calculate the number of repeat frames necessary to obtain such selected fast forward factor on average. The fast forward factor may even be continuously variable.

In the above, it is assumed that top frames are displayed before bottom frames. It will be clear to a person skilled in the art that an empty repeat picture ER of the present invention repeats the last-displayed field of a previous anchor picture; therefore, if bottom fields are displayed before top fields, the top field reference information RT₂ and the bottom field reference information RB₂ of the interlace elimination repeat picture ER both refer to the top field memory. The same applies, mutatis mutandis, for empty preview pictures EP.

Further, although the invention is described for the situation of a fast forward trick play, the invention is not limited to forward play but is equally applicable to reverse play, again with possibly different speed factors.

In the above, the invention is explained for a case where the original video sequence is recorded on a disk-shaped medium. Such disk-shaped medium may contain a magnetic recording or an optical recording. However, the original video sequence may also be recorded on a medium of the tape type, for instance magnetic tape. It should be clear that the player 30 will be adapted to the type of record, in order to be able to read the record. Therefore, where in the description and the claims the general phrase “player” is used, this phrase is intended to cover a magnetic disk player, an optical disk player, a magnetic tape player, etc.

In the above, the invention is explained for a case where the signal as outputted from the player is transmitted to a TV set for direct display. However, the signal as outputted from the player (130: FIG. 8A) may also be recorded on any suitable record medium 135, by any conventional recorder 133 adapted to write such record medium 135. Such recorder 133 may be a separate recorder, or may be integral with the player 130. When the thus recorded compressed digital video recording would be played back by any conventional player in normal speed, and transmitted to a TV set, the resulting display would be a display with trick play speed.

When a trick play video sequence is being generated and recorded, such that later play back at normal speed results in display with a speed differing from the original speed, it is not necessary that the player reads the original recording at an increased speed. As an alternative, a device (player) may be designed to read the original recording at normal speed, to construct the trick play sequence in conformity with the invention as described in the above, and to write the trick play sequence on a suitable medium. Again, when the trick play sequence thus recorded would be played back by any conventional player in normal speed, and transmitted to a TV set, the resulting display would be a display having a speed differing from the speed of the original sequence.

In such a case, it is not necessary that the original video sequence is available in the form of a record. The device may also comprise a receiver (230: FIG. 8B) adapted to receive at an input 236 the original video signal from an external source (not shown for the sake of simplicity), for instance an external player, and to construct a trick play sequence and write the trick play sequence on a suitable medium 235 via a recorder 233.

Alternatively, the device may also comprise a receiver (330: FIG. 8C) adapted to receive a digital video broadcast at an input 337. The input 337 is shown in FIG. 8C as an antenna for receiving a wireless broadcast, but the input 337 may also be a cable input.

Although, in the above, the present invention has been explained for video pictures of interlaced field type, the present invention is equally applicable for progressive video; then, of course, the interlace effect does not play any role.

1. Encoded video signal containing at least one empty picture (E), i.e. a picture without coded macroblocks.

2. Encoded video signal according to claim 1, wherein said empty picture (E) is structured such that, on decoding, each field of this empty picture (E) causes a repeated display of the temporally closest field of the anchor picture to which this empty picture (E) refers, in order to eliminate an interlace effect.

3. Encoded video signal according to claim 1, wherein said empty picture (E) is an empty repeat picture (ER) causing, on decoding, a repeated display of a previous anchor picture.

4. Encoded video signal according to claim 3, said empty repeat picture (ER) having first field reference information referring to a second field (RT→B) in order to eliminate an interlace effect.

5. Encoded video signal according to claim 1, wherein said empty picture (E) is an empty preview picture (EP) causing, on decoding, a repeated display of a future anchor picture.

6. Encoded video signal according to claim 5, said empty preview picture (EP) having second field reference information referring to a first field (RB→T) in order to eliminate an interlace effect.

7. Encoded video signal according to claim 1, wherein said empty picture (E) is an empty repeat/preview picture (ER/P) causing, on decoding, a repeated display of a field of a previous anchor picture followed by a repeated display of a field of a future anchor picture.

8. Encoded video signal according to claim 7, said empty repeat/preview picture (ER/P) having first field reference information referring to a second field (RT→B) and second field reference information referring to a first field (RB→T) in order to eliminate an interlace effect.

9. Encoded video signal according to claim 1, wherein said empty picture (E) is an empty interpolation picture (EI) causing, on decoding, a display of an interpolation between a previous anchor picture and a future anchor picture.

10. Encoded video signal according to claim 9, said empty interpolation picture (EI) being designed to cause, on decoding, two times a display of an interpolation between the second field of the previous anchor picture and the first field of the future anchor picture in order to eliminate an interlace effect.

11. Encoded video signal containing at least one picture having an I-coded first field and having a P-coded empty repeat second field (EB_{P}) with second field reference information referring to said first field (RB→T).

12. Method for generating a compressed video signal on the basis of an original video sequence, preferably according to the MPEG2 format, such that, on decoding and display, the generated compressed video signal results in display with a speed different from the speed of the original video sequence, the method comprising the steps of:
extracting an original intra-coded (I-type) or predictively coded (P-type) picture (X1) from an original video sequence;
and generating and adding an encoded empty picture (E2) behind the extracted original picture.

13. Method according to claim 12, wherein said empty picture is an empty repeat picture (ER2), such that, on decoding, the added empty repeat picture (ER2) causes a repeated display of at least part of the image displayed on decoding said original picture (X1).

14. Method according to claim 13, wherein said empty repeat picture (ER2) has first field reference information (RT2) referring to a second field memory (RT2→B) and second field reference information (RB2) referring to the same second field memory (RB2→B), such that, on decoding, the first field image of said original picture (X1) is displayed once followed by a three times display of the second field image of said original picture (X1).

15. Method according to claim 13 or 14, wherein at least one further empty repeat picture (ER3) is generated and added behind said empty repeat picture (ER2).

16. Method according to claim 15, wherein the first empty repeat picture (ER2) is a predictively coded (P-type) picture, and wherein the further empty repeat picture (ER3) is an empty predictively coded (P-type) picture containing first field reference information (RT3) referring to a first field memory (RT3→T2) and second field reference information (RB3) referring to a second field memory (RB3→B2).

17. Method according to claim 15, wherein the first empty repeat picture (ER2) is a predictively coded (P-type) picture, and wherein the further empty repeat picture (ER3) is an empty bidirectionally predictively coded (B-type) picture containing first field reference information (RT3) referring to a first field memory (RT3→T2) or to a second field memory (RT3→B2), and second field reference information (RB3) referring to a second field memory (RB3→B2).

18. Method according to claim 15, wherein the first empty repeat picture (ER2) is a bidirectionally predictively coded (B-type) picture, and wherein the further empty repeat picture (ER3) is identical to the first empty repeat picture (ER2).

19. Method according to claim 12, wherein said empty picture is an empty preview picture (EP2), such that, on decoding, the added empty preview picture (EP2) causes a preview display of at least part of the future image displayed on decoding said original picture (X1).

20. Method according to claim 1, wherein said empty preview picture (EP2) has first field reference information (RT2) referring to a first field memory (RT2→T) and second field reference information (RB2) referring to the same first field memory (RB2→T), such that, on decoding and display, the first field image of said original picture (X1) is displayed three times followed by a one times display of the second field image of said original picture (X1).

21. Method according to claim 19 or 20, wherein at least one further empty preview picture is generated and added behind said empty preview picture (EP2).

22. Method according to claim 21, wherein the first empty preview picture (EP2) is a bidirectionally predictively coded (B-type) picture, and wherein the further empty repeat picture is identical to the first empty preview picture (EP2).

23. Method for generating a compressed video signal on the basis of an original video sequence, preferably according to the MPEG2 format, such that, on decoding, the generated compressed video signal results in display with a speed different from the speed of the original video sequence, the method comprising the steps of:
extracting a first original intra-coded (I-type) or predictively coded (P-type) frame (X1) from an original video sequence;
extracting a second original intra-coded (I-type) or predictively coded (P-type) picture (X3) from the original video sequence;
and generating and adding an empty picture (E2) behind the two extracted original pictures, such that, on decoding, the added empty picture (E2) causes a repeated display of at least part of the image displayed on decoding said first original picture (X1) as well as a preview display of at least part of the future image displayed on decoding said second original picture (X3).

24. Method according to claim 23, wherein said empty picture (E2) has first field reference information (RT2) referring to a second field memory (RT2→B1) and second field reference information (RB2) referring to a first field memory (RB2→T3)), such that, on decoding, the second field image of said first original picture (X1) is displayed two times followed by a two times display of the first field image of said second original picture (X3).

25. Method for generating a compressed video signal on the basis of an original video sequence, preferably according to the MPEG2 format, such that, on decoding, the generated compressed video signal results in display with a speed different from the speed of the original video sequence, the method comprising the steps of:
extracting an original intra-coded (I-type) or predictively coded (P-type) picture (X1) from an original video sequence, this original picture being field-based coded and comprising an original first field (T_{I}1; T_{P}1) and an original second field (B_{I}1; B_{P}1);
and replacing the original second field (B_{I}1; B_{P}1) by a copy of said original first field (T_{I}1; T_{P}1).

26. Method for generating a compressed video signal on the basis of an original video sequence, preferably according to the MPEG2 format, such that, on decoding, the generated compressed video signal results in display with a speed different from the speed of the original video sequence, the method comprising the steps of:
extracting an original intra-coded (I-type) or predictively coded (P-type) picture (X1) from an original video sequence, this original picture being field-based coded and comprising an original first field (T_{I}1; T_{P}1) and an original second field (B_{I}1; B_{P}1);
generating an individually (field-based) predictively coded (P-type) empty second field picture (EB_{P}), having a reference to the first field memory (RB→T);
and replacing the original second field (B_{I}1; B_{P}1) by the said generated empty second field picture (EB_{P}(RB→T)), such that, on decoding and display, the said empty second field picture (EB_{P}(RB→T)) causes a repeated display of the first field image of said original picture (X1).

27. Method according to claim 25 or 26, wherein at least one empty repeat picture is generated and added behind the said amended second field picture (T_{I}1; T_{P}1; EB_{P}(RB→T)).

28. Method according to claim 27, wherein at least one of said empty repeat pictures is either an empty predictively coded (P-type) picture or an empty bidirectionally predictively coded (B-type) picture, containing first field reference information (RT) referring either to a first field memory (→T) or to a second field memory (→B), and containing second field reference information (RB) referring to the second field memory (→B).

29. Method according to any of claims 12-28, wherein:
a first original picture is extracted from the original video sequence;
a first empty picture is generated and added behind the first extracted original picture;
a first predetermined number of further empty pictures are generated and added behind the first empty picture;
a second original picture is extracted from the original video sequence;
a second empty picture is generated and added behind the second extracted picture;
a second predetermined number of further empty pictures are generated and added behind the second empty picture;
such that, on decoding, a first image is repeatedly displayed said first predetermined number plus two times, while a second image is repeatedly displayed said second predetermined number plus two times;
wherein the first predetermined number and the second predetermined number are different from each other.

30. Method according to any of the previous claims 12-29, for generating a slow motion sequence, wherein all original pictures of the original video sequence are used for generating a slow motion play sequence.

31. Method according to any of the previous claims 12-29, for generating a fast motion sequence, wherein a limited number of original pictures of the original video sequence are used for generating a fast motion play sequence.

32. Method according to claim 31, wherein only anchor pictures of the original video sequence are used for generating a fast motion play sequence.

33. Method according to claim 32, wherein only intra-coded anchor pictures of the original video sequence are used for generating a fast motion play sequence.

34. Apparatus for processing an original video sequence and for generating a compressed video trick play signal resulting, on decoding, in a display speed different from the normal speed of the original video sequence, the apparatus being designed to perform the method according to any of the previous claims.

35. Apparatus according to claim 34, comprising a player (30; 130) suitable for reading the original video sequence from a record carrier (31; 131), and having an output (32; 132) for outputting the generated video trick play signal.

36. Apparatus according to claim 35, further comprising a recorder (133) having an input (134) connected to the output (132) of the player (130), the recorder (133) being arranged for recording, on a record medium (135), the video trick play signal generated by the player (130).

37. Apparatus according to claim 36, wherein the player (130) and the recorder (133) are combined as one integral recording/playback device.

38. Apparatus according to claim 34, comprising a receiver (230) having an input (236) for receiving the original video sequence from an external source, and having an output (232) for outputting the generated video trick play signal;
the apparatus further comprising a recorder (233) having an input (234) connected to the output (232) of the player (230), the recorder (233) being arranged for recording, on a record medium (235), the video trick play signal generated by the player (230).

39. Apparatus according to claim 34, comprising a receiver (330) having an input (337) for receiving the original video sequence as a digital video broadcast, and having an output (332) for outputting the generated video trick play signal;
the apparatus further comprising a recorder (333) having an input (334) connected to the output (332) of the player (330), the recorder (333) being arranged for recording, on a record medium (335), the video trick play signal generated by the player (330).

40. Apparatus according to any of claims 38-39, wherein the receiver (230; 330) and the recorder (233; 333) are combined as one integral unit.

41. Apparatus according to claim 34 or 35, adapted to generate a sequence of empty repeat pictures in a pause mode or in a still image mode.

42. Apparatus according to claim 41, adapted to include an original intra-coded picture into said sequence, always after a predetermined number of empty repeat pictures.

43. Record carrier (135; 235; 335) carrying a recorded compressed digital video trick play signal which results, on normal playback, in display with a refresh rate different from the standard refresh rate of original video sequences.

44. Record carrier according to claim 43, carrying a recorded compressed digital video trick play signal which results, on normal playback, in display with a refresh rate different from the standard refresh rate of original video sequences, free from any interlace effect.

45. Record carrier according to claim 43 or 44, wherein the compressed digital video trick play signal recorded thereon comprises at least one signal according to any of claims 1-11.

46. Record carrier according to claim 43 or 44, wherein the compressed digital video trick play signal recorded thereon comprises at least one sequence of an original intra-coded (I-type) or predictively coded (P-type) picture (X1) from an original video sequence followed by an empty repeat picture (ER2), such that, on decoding in normal play speed, the said empty repeat picture (ER2) causes a repeated display of at least part of the image of said original picture (X1).

47. Record carrier according to claim 46, said empty repeat picture (ER) having first field reference information referring to a second field (RT→B) in order to eliminate any interlace effect, such that, on decoding and display, the first field image of said original picture (X1) is displayed once followed by a three times display of the second field image of said original picture (X1).

48. Record carrier according to claim 43 or 44, wherein the compressed digital video trick play signal recorded thereon comprises at least one sequence of an original intra-coded (I-type) or predictively coded (P-type) picture (X3) from an original video sequence followed by an empty preview picture (EP2), such that, on decoding in normal play speed, the said empty preview picture (EP2) causes a preview display of at least part of the future image of said original picture (X3).

49. Record carrier according to claim 48, said empty preview picture (EP) having second field reference information referring to a first field (RB→T) in order to eliminate any interlace effect, such that, on decoding, the first field image of said original picture (X3) is displayed three times followed by a one times display of the second field image of said original picture (X3).

50. Record carrier according to claim 43 or 44, wherein the compressed digital video trick play signal recorded thereon comprises at least one sequence of a first original intra-coded (I-type) or predictively coded (P-type) picture (X1) from an original video sequence, a second original intra-coded (I-type) or predictively coded (P-type) picture (X3) from an original video sequence, and an empty picture (E2), such that, on decoding and display in normal play speed, the said empty picture (E2) causes a repeated display of at least part of the image displayed on decoding said first original picture (X1) as well as a preview display of at least part of the future image displayed on decoding said second original picture (X3).

51. Record carrier according to claim 50, said empty picture (E2) having first field reference information (RT2) referring to a second field memory (RT2→B1) and second field reference information (RB2) referring to a first field memory (RB2→T3)) in order to eliminate any interlace effect, such that, on decoding, the bottom field image of said first original picture (X1) is displayed two times followed by a two times display of the first field image of said second original picture (X3).
